(19) United States
(12) Patent Application Publication
(10) Pub. No.: US 2008/0151454 A1
(43) Pub. Date: Jun. 26, 2008

(54) Electronic Battery Safety Switch

(75) Inventor: Gunter Uhl, Helmstadt-Bargen (DE)

Correspondence Address: BOYLE FREDRICKSON S.C., 840 North Plankinton Avenue, MILWAUKEE, WI, 53203, US

(73) Assignee: CATEM DEVELEC GMBH, Herxheim (DE)

(21) Appl. No.: 11/569,137

(22) PCT Filed: May 25, 2005
(86) PCT No.: PCT/EP05/05684

§ 371 Date: Sep. 20, 2007

(30) Foreign Application Priority Data
May 28, 2004 (EP) 04012787.0

(51) Int. Cl. B60R 21/01; H02H 3/08

(52) U.S. Cl. 361/87; 307/10.7

(57) ABSTRACT

The invention relates to an electronic battery safety switch which facilitates a reliable and reversible disconnection of the motor vehicle on-board network from the battery. For this purpose an electronic solid-state switch is used which facilitates an unlimited number of switching cycles. The solid-state switch electrically disconnects the motor vehicle on-board network and the battery with the application of a crash signal or an overcurrent signal or when the ignition is switched off. With a parked vehicle an impermissibly high idle current and a discharge of the battery can be reliably prevented in an effective and simple manner. If the current flows from the on-board network in the direction of the battery, then the solid-state switch is switched actively conducting. Thus, damage to the switch in the inverse mode can be prevented.

### BACKGROUND OF THE INVENTION

1. Field of the Invention

The invention relates to an improved battery safety switch for motor vehicles.

2. Description of the Related Art

A battery safety switch is connected in motor vehicles between the battery and the motor vehicle on-board network. During an accident the battery safety switch disconnects the battery from the motor vehicle on-board network to prevent a fire or explosion being caused by escaping fuel and an electrical short circuit. The risk of a short circuit is particularly high with those motor vehicles which have the battery arranged at the rear of the vehicle. With these vehicles POSITIVE wires with a large cross-sectional area are located in the vehicle floor between the engine compartment and the rear of the vehicle. The large cross-sectional areas lead to correspondingly high short-circuit currents during an accident.

Conventional battery safety switches facilitate an abrupt disconnection of the motor vehicle onboard network from the battery via an electromagnetically or pyrotechnically opened contact. When an externally fed trigger signal is applied, the normally closed contact is opened by igniting the pyrotechnical charge or electromagnetically. The externally fed accident or “crash” signal is generally taken from the motor vehicle air bag system. When the air bags trigger, immediate disconnection of the battery also occurs. This type of electromagnetically actuated battery safety switch is for example known from DE-C1-198 25 245.

A disadvantage with conventional battery safety switches is that the disconnection of the battery does not occur with those accident scenarios in which the air bag system is not activated. In particular with a diagonal collision of a motor vehicle with a crash barrier crash sensors do not produce any accident signal. Particularly strong retardation does not occur with this scenario so that the crash sensor in the air bag system does not trigger. With such an accident however, the high current wires in the floor panel of the motor vehicle are frayed through.

Conventional battery safety switches, in particular those operating on a pyrotechnical principle, irreversibly disconnect the battery from the motor vehicle on-board network. Once the battery safety switch has triggered, the motor vehicle cannot initially be driven, even after an accident without much consequential damage. The motor vehicle can only be moved under its own power after the battery safety switch has been replaced.

Electromagnetically operated battery safety switches can be reset again after a minor accident which leads to no major damage. Due to the wear of the electromechanical contacts when switching high currents, these safety switches however only permit a very limited number of switchings, normally only a maximum of 10 to 50 switching actions. Disconnection of the battery via these battery safety switches is therefore only considered in exceptional cases.

### OBJECT OF THE INVENTION

The object of the invention is therefore to provide an improved battery safety switch.

The object is solved by the features of the independent patent claim.

The battery safety switch according to the invention is used to separate an electrical connection between the battery of a motor vehicle and a motor vehicle on-board network. The battery safety switch comprises a solid-state switch for connecting and disconnecting the battery and the motor vehicle on-board network in dependence of an overcurrent and/or a crash signal.

In the present invention a solid-state switch is used for the electrical connection or disconnection of the battery and the on-board network. In contrast to electromechanically actuated switching contacts, a solid-state switch facilitates an unlimited number of switching cycles. In addition a solid-state switch can be reset in a simple manner. With the battery safety switch according to the invention a disconnection needs therefore not be restricted like conventional ones to extraordinary emergencies.

A special approach of the present invention is the design of the solid-state switch for bi-directional operation. In this respect the solid-state switch is switched conducting when the voltage of the on-board network is greater than the battery voltage. Therefore a current can flow into the battery as well as out of the battery via the solid-state switch. A current flowing in the direction of the battery cannot be interrupted by the solid-state switch. Here, high dissipation losses occur with a solid-state switch which is not being driven and this may lead to thermal damage. For this reason the direction of current flow through the solid-state switch is permanently monitored. If the current flows in the direction of the battery, then the solid-state switch is switched actively conducting and therefore enters the inverse mode with low power dissipation. Thus, the power loss on the solid-state switch is reduced and damage or destruction can be prevented.

Preferably the solid-state switch is a MOSFET.

According to a preferred embodiment of the invention, the solid-state switch of the battery safety switch is not just used for an emergency switch-off, but rather also frequently in the position “Ignition OFF” to disconnect the motor vehicle on-board network from the battery. This disconnection is conventionally implemented by a so-called “terminal 15 switch”. The terminal 15 switch is a contact in the ignition switch which is closed on switching on the ignition. However, since such an ignition switch cannot switch high currents, an additional relay is increasingly being used for this purpose which is activated on switching on the ignition. This type of relay as a terminal 15 switch is generally not used for disconnecting loads requiring high currents. In contrast to this, the battery safety switch according to the invention also takes over the function of the previous terminal 15 switch, because it enables an unlimited number of switching cycles and also trouble-free switching of high currents.

In comparison to conventional terminal 15 switches the battery safety switch according to the invention exhibits a higher current-carrying capacity. The invention therefore also enables those loads to be disconnected from the on-board network in the position Ignition OFF which are conventionally permanently connected to the motor vehicle on-board network. In particular loads with very high operating currents, such as electrical supplementary heaters, for example PTC heaters, and glow systems were previously not disconnected from the on-board network by the terminal 15 switch. Further examples of loads which are not disconnected from the on-board network with the ignition switched off are the rear window heater, seat heater and fan controller for the engine cooling and the interior fan. According to this preferred embodiment of the invention, the problems can be remedied which arise from the possible high idle current consumption of conventional vehicle components which are permanently connected to the battery.

Additionally, this advantageous embodiment facilitates increased safety. According to the invention the battery safety switch also disconnects those loads from the battery which conventionally are permanently connected to the battery. In particular, conventional electrical supplementary heaters were not disconnected from the battery. Electrical supplementary heaters are increasingly equipped with a power electronics controller. The failure of a power electronics final stage can lead to permanent operation of the corresponding heating stage and thus to continuous current flow and a draining of the battery. According to the invention this problem is solved in a simple and reliable manner.

A similar problem also arises with interior fan controllers with which similar critical operating states arise when the heavily loaded transistor of the linear regulator breaks down/overheats and a continuous flow of current occurs. This flow of current can similarly be prevented with the aid of the battery safety switch according to the invention.

According to a further advantageous embodiment of the invention, the battery safety switch is equipped with a current measurement function for monitoring the current flowing from the battery into the motor vehicle on-board network. This type of purely electronically realised, integrated overcurrent and short-circuit switch-off facilitates a significantly quicker disconnection of the battery and on-board network in the case of a fault condition. Due to the fully electronic implementation of the monitoring and switch-off, conventionally relevant trigger and switching delays are negligible. The detection of an overcurrent condition and an ensuing disconnection of the on-board network from the battery can in comparison to an implementation with an electromechanical switch take place in less than 100 μs.

Preferably the battery safety switch, which is equipped with a current measurement function integrated into the solid-state switch, also comprises a control unit for evaluating the measured current and for controlling the solid-state switch for disconnecting the electrical connection between the battery and the motor vehicle on-board network. Compared to a solution with a conventional electromagnetically actuated switching contact with a current-dependent trigger, an electronic switch with integrated current measurement offers the advantage of a significantly reduced circuit complexity and is thus more economical to manufacture.

For the appropriate implementation of an electromagnetically actuated switching contact, in addition to the electromagnetically actuated switch, a measurement shunt for the current measurement, measurement conditioning (for example, via an operational amplifier) and a microcontroller for the current evaluation and relay drive are required. For an implementation with a solid-state switch, which comprises an integrated current measurement, apart from the solid-state switch, only a control unit for the current evaluation and a drive for the solid-state switch are required.

A purely electronically implemented overcurrent or short-circuit switch-off facilitates a significantly faster switch-off. The safety switch according to the invention, implemented purely electronically, exhibits, in contrast to conventional safety switches, negligible trigger and switching delays. The detection of an overcurrent condition and the ensuing switch-off of the on-board network can, in comparison to an implementation with an electromechanical switch, take place in less than 100 νs. When the load circuit is switched off, less current flows due to the finite rate of rise of current due to the inductance of the load circuit (arc formation, contact loading, etc.).

The control unit compares the measured current value preferably with a specified limit. According to a further preferred embodiment, this limit can be adjusted adaptively. In this way the safety circuit can variably adapt to different operating states of the motor vehicle. Only briefly occurring high currents can be tolerated. Additionally, the starting process of the engine, during which high currents flow via the on-board network from the battery to the starter, can be reliably detected and tolerated.

Preferably the control unit signals an overcurrent situation to the solid-state switch once the measured current exceeds the limit.

The crash signal is preferably an air bag trigger signal. In this way an accident can be detected very simply without additional complexity.

Preferably the battery safety switch is equipped for mounting on a battery connection. The switch-off of the current feed to the on-board network can thus take place close to the battery and short circuits can be reliably prevented.

According to a preferred embodiment, a battery monitoring function is integrated into the battery safety switch. The monitoring function preferably monitors the voltage, temperature and the current flowing into or out of the battery. With these parameters the control unit can in a simple manner determine the battery condition, in particular a SOC and SOH condition.

According to a further preferred embodiment the battery safety switch monitors the idle current consumption of the motor vehicle on-board network in the position “Ignition OFF”. Through the evaluation of the measured idle current an impermissibly high idle current and thus draining of the battery can be promptly detected and prevented. For this purpose preferably the loads also connected to the battery in the position “Ignition OFF” are disconnected from the battery when the idle current from the battery exceeds a specified limit.

Further preferred embodiments form the subject matter of the dependent claims.

In the following the present invention is explained based on preferred embodiments in conjunction with the enclosed drawings. Here, the drawings show individually:

### BRIEF DESCRIPTION OF THE DRAWINGS

FIG. 1 the structure of a motor vehicle on-board network with a conventional battery safety switch

FIG. 2 a motor vehicle on-board network with an electronic battery safety switch according to the present invention, and

FIG. 3 a motor vehicle on-board network according to FIG. 2 with an alternative embodiment for switching off continuously active loads.

### DETAILED DESCRIPTION OF THE PREFERRED EMBODIMENT

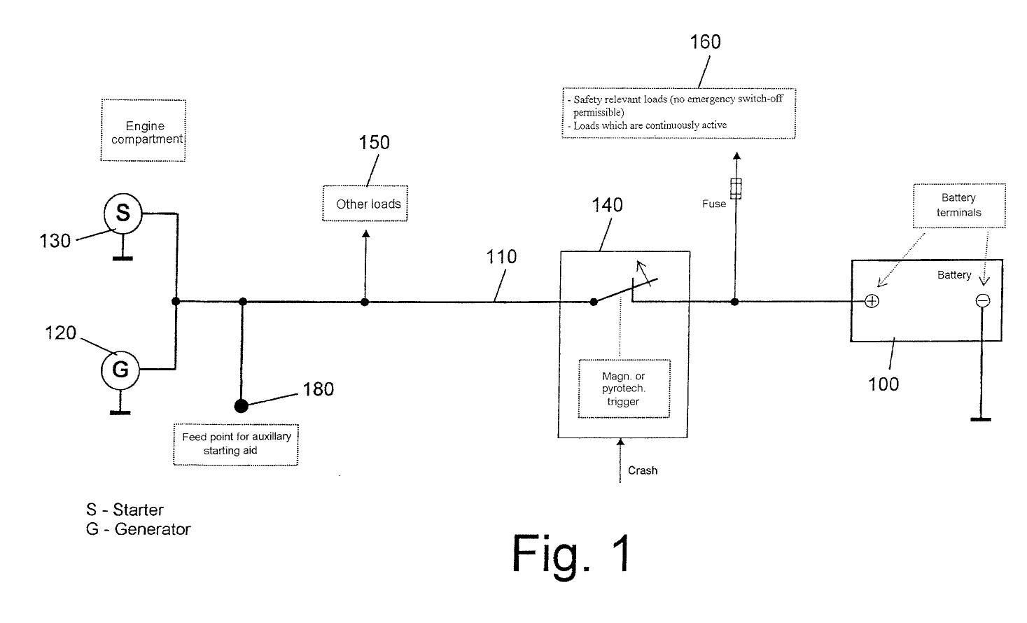

FIG. 1 shows in a schematic manner the structure of a conventional motor vehicle on-board network. The battery 100 is connected to the motor vehicle on-board network 110 via a battery safety switch 140. A generator 120, a starter 130 and other loads 150 are connected to the motor vehicle on-board network 110. An additional connection 180 is provided for the current feed for starting aids from other vehicles.

Whereas the generator 120 feeds electrical current to the motor vehicle on-board network 110 when the vehicle engine is running, the battery 100 stores the energy provided by the generator 120 during the operation of the engine. To put the engine into operation, a chemical reaction in the battery 100 produces electrical energy which is passed to the starter 130.

The battery safety switch 140 is actively switched off with the presence of an overcurrent signal or a crash signal. This means that with the application of a trigger signal the switch is opened either pyrotechnically or electromagnetically so that the motor vehicle on-board network 110 is disconnected from the battery 100.

Safety-relevant loads 160, for which no emergency switch-off is permissible or which must be continuously active, are excluded from the emergency switch-off. For this purpose they are connected to the battery by bypassing the battery safety switch 140.

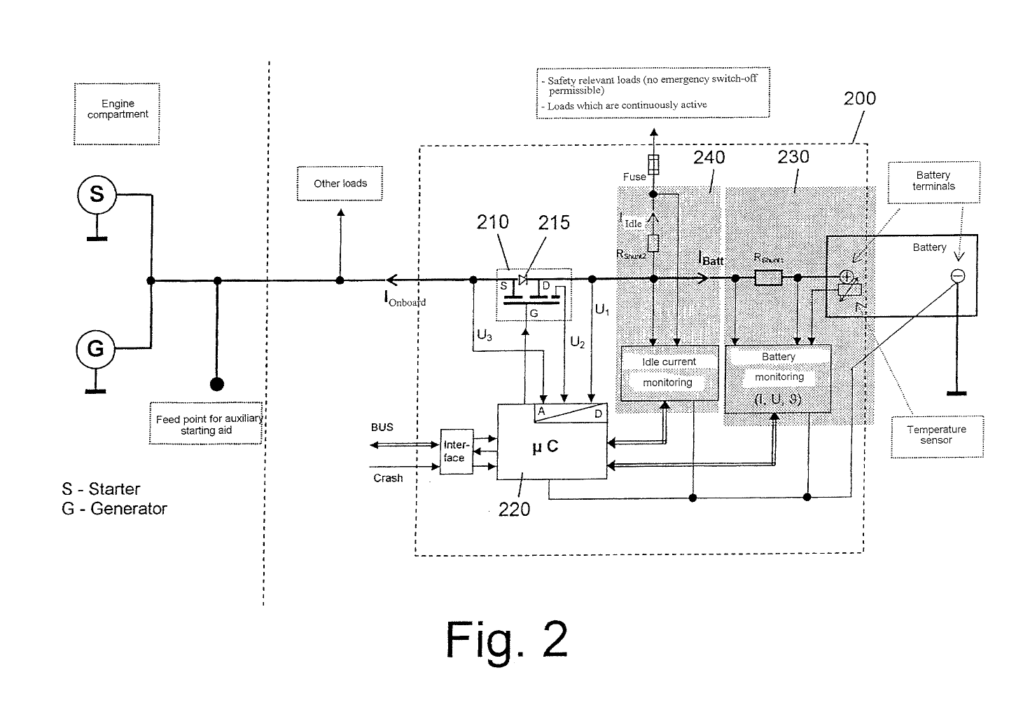

An electronic battery safety switch according to the present invention is illustrated in FIG. 2. Instead of the conventional battery safety switch 140 as in FIG. 1, according to the invention an electronic battery safety switch 200 is used. The battery safety switch in the present invention comprises as a central element a high current solid-state switch 210. This solid-state switch is preferably a MOSFET.

The current from and to the battery is switched through the control unit 220 by the solid-state switch 210 in line with the control. Depending on an externally fed crash signal or an overcurrent situation detected by the battery monitoring system, the solid-state switch 210 abruptly interrupts the electrical connection between the battery and the motor vehicle on-board network.

The solid-state switch is equipped with an integrated current measurement function for monitoring the current flowing into and out of the battery. Such a solid-state switch is for example obtainable as a “Smart Highside High Current Power Switch” BTS 555 from the company INFINEON. Generally, a number of these solid-state switches, normally 2 to 4, are wired in parallel to switch very high currents.

The solid-state switch 210 is operated in the bi-directional mode—referred to the direction of the current flow. The current flows not only from the drain D to the source S, but also in the reverse direction from S to D. Although this type of bi-directional mode is in principle permissible due to the symmetrical construction of a MOSFET, it must be ensured with this mode that the MOSFET is driven in the inverse mode, i.e., with the current flow from S to D, such that the D-S path is conducting. To achieve this, the voltage on the gate terminal G is higher than the voltage on D and S. This prevents the inversely flowing current passing through the internal body diode 115. Such a current would, due to the increased voltage drop, lead to thermal damage to the MOSFET, because the conducting-state voltage of a diode is generally about 1.2 V. Irrespective of the current direction only a few hundreds of millivolts are dropped across the D-S section in the conducting state.

In the inverse mode of the MOSFET the voltage on the source terminal S is higher than on the drain terminal D, so that current flow occurs due to the internal, immanent body diode. With correspondingly high currents, the high conducting-state voltage of a diode with a U_{D} of about 1 V leads to an impermissibly high power dissipation and correspondingly high heating. With a current of 100 A the power dissipation is about 100 W. In normal operation though the power dissipation is determined by the conduction-state resistance of the MOSFET R_{Dson}. This resistance is in the region of about 1 mΩ so that the power dissipation only reaches a value of about 10 W. It is therefore particularly important to detect the inverse mode of a MOSFET and to drive a MOSFET in the inverse mode so that the current flows “inversely” via the conducting drain-source path and not through the body diode of the MOSFET.

According to a preferred embodiment, the solid-state switch is designed for a bi-directional mode of the current from and to the battery (normal mode resp. inverse mode). The solid-state switch can therefore pass a current that flows into the battery and also one that flows out of it. The current flow through the solid-state switch can be interrupted only in normal operation. In this respect the solid-state switch switches to the inverse mode when the voltage of the on-board network is greater than the battery voltage.

In the normal mode the current I_{Onboard} flows via the solid-state switch 210 into the motor vehicle on-board network. This current is continuously monitored by the current measurement function integrated into the solid-state switch and is available as the measurement voltage U₂ to the control unit 220. In this connection the normal mode means that the ignition is switched on and the solid-state switch 210 is switched on as the result of a control signal received from the control unit 220 through or via a data bus. At this point in time the generator 120 still supplies no power and the current requirement of the motor vehicle on-board network 110 including the current for the starter 130 is covered exclusively by the vehicle battery 100.

Once the vehicle engine is started with the aid of the starter 130, the generator 120 starts to produce current. The current requirement of the motor vehicle on-board network is now covered by the generator. At the same time the battery is charged by the current produced by the generator. As the generator 120 starts to produce current the current flow through the solid-state switch 210 changes its direction. The solid-state switch is now operating in the inverse mode.

An intentional inverse mode must be reliably detected, even with a non-active solid-state switch, i.e., one that is switched conducting, for the case in that current is fed, with the ignition not switched on, to the feed point 180 as an external starting aid from another motor vehicle or an external auxiliary battery. In contrast, in the normal mode the voltage is fed in the reverse direction from the positive pole on the battery to the starter.

To ensure reliable detection of this inverse mode, the voltage U₃, i.e. the voltage of the on-board network, is monitored. In the non-active state (ignition OFF) this is zero. However, if the onboard network voltage U₃ becomes higher than the battery voltage U₁, the solid-state switch 210 is driven such that the D-S path becomes conducting and a current flow in both directions is possible.

The current monitoring preferably occurs not simply by monitoring a fixed limit above which the current feed from the battery is automatically interrupted. The overcurrent acquisition can be adapted to various vehicle operating states through a dynamic adaptation of the current limits or current limit curves. Thus for example, a starting process can be differentiated from a short circuit. For this purpose a very specific current profile is used as the limiting curve during the starting process. This type of current profile for the starting process permits short current peaks of up to 1000 amperes (for example, caused by the rotor of the starter breaking away) and does not cause any switch-off of the battery safety switch.

After the successful start of the vehicle engine the limit for the detection of a short circuit is reduced however to a value of, for example, 100 amperes. A current of the order of magnitude of 1000 amperes is then detected as a short circuit and the solid-state switch appropriately opened.

Switching off the current feed from the battery into the motor vehicle on-board network by the solid-state switch occurs according to the invention with the presence of one of the following conditions:

a) Ignition OFF;

b) Detection of a short circuit, i.e. of an overcurrent; and

c) Presence of an external crash signal.

In these cases it is assumed that the internal combustion engine is stationary or has been switched off and the generator itself is no longer producing current.

The control of all functions of the electronic solid-state switch occurs through the control unit 220, which comprises an integrated analogue/digital converter. Its functions include the measurement of the voltages U₁, U₂, U₃ and other quantities, assessment of the measured quantities, driving the solid-state switch and processing the signals for monitoring the idle current consumption of the motor vehicle on-board network.

The control unit 220 is connected to the vehicle bus network via an interface, for example, a CAN or a LIN bus. External control signals, for example the signal Ignition OFF, are fed to the control unit 220 via this bus. Also a crash signal can be transferred via this bus. Alternatively, the crash signal can also be fed to the control unit 220 separately. A directly (bypassing the data bus) fed crash signal is not subject to delay by the data bus and switches off the solid-state switch 210 reliably and immediately.

According to a preferred embodiment of the present invention, the battery safety switch 200 is equipped with a battery monitoring system. A battery management system is these days often already installed in top class vehicles. Such a battery management system monitors important battery parameters such as voltage, temperature and stored energy. Based on this data a reliable engine start can be ensured even after longer idle periods. For this purpose the voltage of the battery, the temperature of the battery and the current I_{Batt} flowing out of or into the battery are acquired. A current balance is produced from the current flowing into the battery and the current flowing out of the battery. Based on the acquired values, the battery condition in terms of SOC (State Of Charge) and SOH (State Of Health) is calculated with the aid of suitable computational models.

This type of battery monitoring system is integrated as an additional component 230 into the electronic battery safety switch 200 according to the invention. For this purpose, appropriate measurement devices are provided for the battery voltage, battery temperature and the measurement of a bi-directional current over a wide measurement range (between 1 and 1000 amperes). The current measurement preferably occurs with the aid of precision measurement shunts (R_{Shunt1}). The measurement shunt produces a measurement voltage proportional to the current. These functions can be integrated into the electronic battery safety switch according to the invention in a simple manner using an ASIC.

Preferably, the battery safety switch 200 according to the invention also facilitates monitoring of the idle current consumption of the motor vehicle on-board network which is integrated into the battery safety switch as component 240. For the measurement of the idle current out of the battery into the on-board network, i.e., the current in the position Ignition OFF, current measurement via the resistance R_{Shunt1} cannot however be used. Another measurement shunt, R_{Shunt2}, is used to measure the current consumption out of the battery, i.e., the current I_{idle}. The idle current can be permanently monitored and balanced via this idle current measurement shunt with the vehicle parked, that is with the position Ignition OFF.

The idle current includes the currents flowing to all loads 160 which are also connected to the battery in the position Ignition OFF. In particular, those loads generally permanently connected to the battery are loads such as an electrical supplementary heater, an electrical glow system, a rear window heater, a seat heater, a fan controller for the engine cooling system and an interior fan, a radio locking system, clocks, a vehicle entertainment and information system, etc. These loads can also cause draining of the battery with the ignition switched off and thus prevent the restarting of the vehicle.

The current idle is permanently measured to also detect brief current peaks. The measured current is averaged over time to be able to determine the mean current consumption. In this way it is possible to not only detect a brief, impermissibly high current, but also an increased mean idle current consumption. An increased idle current consumption can for example be caused by frequently switching on single systems which are active in the position Ignition OFF.

A load which is permanently connected to the battery is for example the radio locking system. A typical requirement for a system permanently connected to the motor vehicle is generally that the mean current consumption should not exceed a value of 100 μA. With systems with a higher current consumption in the active state, this can be achieved in that the current consumption is reduced by putting the system into a special idling operating state. For example, the current consumption of a radio locking system can be reduced to a value of only 50 μA in that only the radio receiver itself is active and all other components of the radio locking system are however deactivated. In an operating state with somewhat increased activity other circuit parts of the radio locking system are also activated and the current consumption increases significantly accordingly, for example to 50 μA. The transition to such an operating state with increased current consumption is also required to evaluate received data and to decide whether an authorised code has been received. As long as the temporal activation of the operating state with increased current consumption is infrequent and the dwell time in both operating states exhibits for example a ratio of 1000:1, the mean current consumption lies below the value of 100 μA.

Due to external interference, for example interference signals from fluorescent lamps or the transmitted signals from other radio locking systems in a multi-story car park, the vehicle's radio locking system is put into the operating state with a higher current consumption much more often than corresponds to the above ratio. Thus, the mean current consumption increases to a value which is significantly above the limit of 100 μA.

In order to protect the battery from an impermissible discharge, an appropriate switch-off of certain systems can be initiated by the control unit.

According to a first preferred embodiment, the switch-off is effected with the aid of the motor vehicle data bus. Control units and components which are connected to the data bus in the motor vehicle can be fully (partially) deactivated by a command sent out from the control unit 220 of the battery safety switch 200. A radio locking system disabled in this way can no longer be used for remotely opening the vehicle locking system. However, since discharging of the battery by the radio locking system during the idle period of the vehicle could according to the invention be prevented, the vehicle can be opened mechanically with the key and also started again under its own power.

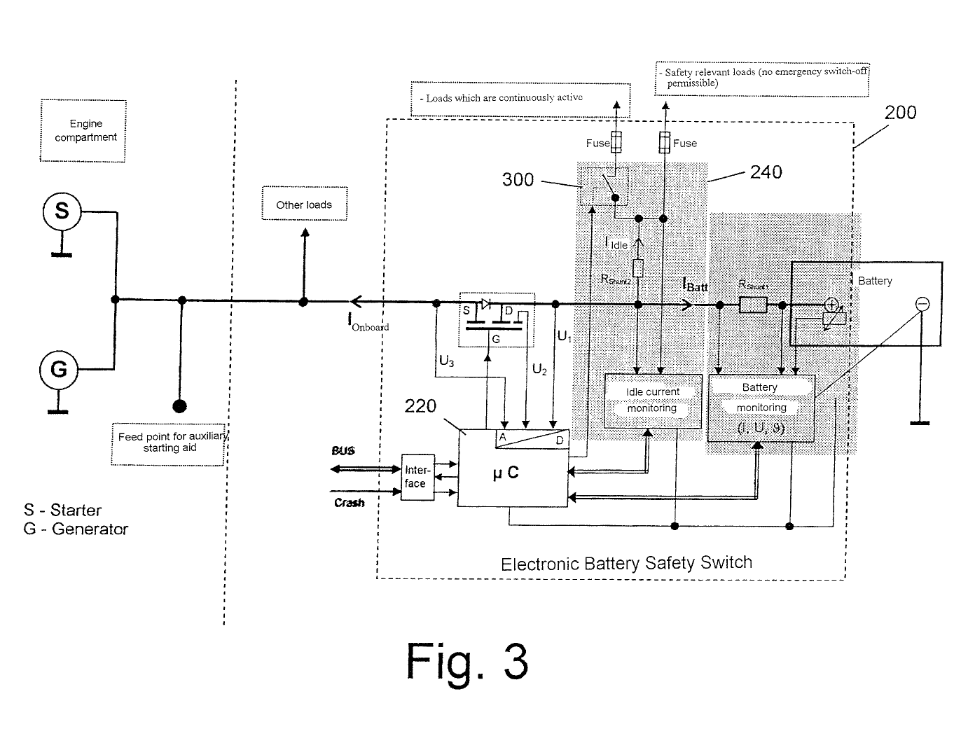

According to an alternative embodiment a further switch is provided in the battery safety switch of the invention. The construction of this modified embodiment is illustrated in FIG. 3. For this purpose the loads continuously connected to the motor vehicle on-board network are subdivided into two categories and in fact depending on whether a switch-off is permissible or not for reasons of safety.

The loads for which a switch-off is permissible are connected to the on-board network via a switch 300 arranged in the battery safety switch 200, in particular in the monitoring device 240. When the control unit 220 establishes that the idle current flowing out of the battery exceeds a specified limit, the switch 300 is opened to interrupt the impermissibly high current flow and to prevent the battery being discharged. This switch-off occurs at the cost of the vehicle's functionality, but can save the user considerable losses, in particular the costs and time involved for a breakdown service.

The motor vehicle on-board network 110 is in principle designed as a parallel circuit of the voltage sources, i.e., of the battery 100 and the generator 120, and the loads. All loads are either directly or indirectly connected to the positive potential, as a direct contact with the positive battery terminal and with ground. The permanent positive potential in the motor vehicle onboard network is designated “terminal 30”. In contrast, all loads connected to “terminal 15” are only applied to the positive potential when the ignition is switched on and the “terminal 15 switch” provides a connection to the positive potential permanently applied to terminal 30.

Due to the unlimited number of possible switching cycles of the solid-state switch 210, the function of the “terminal 15 switch” is according to the invention also transferred to the solidstate switch 210. The solid-state switch can reliably switch idle currents, briefly up to 1000 A and of a few hundreds of amperes in continuous operation.

Thus, also supplementary loads with a high idle current which are conventionally permanently connected to the positive potential can be reliably disconnected from the motor vehicle on-board network. Also when these loads are controlled conventionally such that they are deactivated when the vehicle is parked, a high idle current can still flow, in particular when a malfunction occurs. For example, a power semiconductor component in a permanently connected load can cause permanent operation if it fails. By the use according to the invention of a solid-state switch in a battery safety switch to which, at the same time, is assigned the function of the terminal 15 switch, such an impermissibly high idle current and a corresponding battery discharge can be simply and reliably prevented.

Through the use of the battery safety switch as disconnector in the position Ignition OFF, more loads than in the conventional case can be disconnected from the supply voltage with the vehicle parked and thus unnecessary and defective current consumption can be avoided on the stationary vehicle.

The electronic battery safety switch of the present invention is preferably installed very close to the battery. Thus, the unprotected cable between the battery and the battery safety switch can be kept as short as possible. For this purpose the battery safety switch 200 is preferably realized in a module which is mounted at or on the battery and directly comprises the positive terminal of the battery. With this type of implementation there is no unprotected cable between the battery and the battery safety switch.

Summarizing, the invention relates to an electronic battery safety switch which facilitates a reliable and reversible disconnection of the motor vehicle on-board network from the battery. For this purpose an electronic solid-state switch is used which facilitates an unlimited number of switching cycles. If the current flows from the motor vehicle on-board network in the direction of the battery, then the solid-state switch is switched actively conducting. Thus, damage to the switch in the inverse mode can be prevented. The solid-state switch electrically disconnects the motor vehicle on-board network and the battery with the application of a crash signal or an overcurrent signal or when the ignition is switched off. With a parked vehicle an impermissibly high idle current and discharge of the battery can be reliably prevented in an effective and simple manner.

1. Battery safety switch for the electrical disconnection of the battery of a motor vehicle and a motor vehicle on-board network, said battery safety switch comprising a solid-state switch for the connection and disconnection of the battery and the motor vehicle on-board network in dependence of an overcurrent and/or a crash signal,
wherein
the solid-state switch is designed for bi-directional operation of the current, and
the solid-state switch s switched conducting when the voltage of the on-board network is greater than the battery voltage.

2. Battery safety switch according to claim 1, wherein the solid-state switch a MOSFET.

3. Battery safety switch according to claim 1, wherein the solid-state switch disconnects the motor vehicle on-board network from the battery also in the position Ignition OFF.

4. Battery safety switch according to claim 3, wherein the solid-state switch disconnects electrical loads with a high idle current consumption, in particular electrical supplementary heaters and/or glow systems, from the battery in the position Ignition OFF.

5. Battery safety switch according to claim 1, wherein the solid-state switch equipped with a current measurement function for monitoring the current flowing out of the battery into the motor vehicle on-board network.

6. Battery safety switch according to claim 5, further comprising a control unit for the evaluation of the current measured by the solid-state switch and for the control of the solid-state switch for the disconnection of the electrical connection between the battery and the motor vehicle on-board network.

7. Battery safety switch according to claim 6, wherein the control unit compares the current measured by the solid-state switch with a specified limit.

8. Battery safety switch according to claim 7, wherein the limit can be adjusted adaptively.

9. Battery safety switch according to claim 7, wherein the control unit signals an overcurrent to the solid-state switch when the limit is exceeded.

10. Battery safety switch according to claim 1 wherein the crash signal is an air bag trigger signal.

11. Battery safety switch according to claim 1, which is designed for attachment to a battery terminal.

12. Battery safety switch according to claim 1, further comprising a battery monitoring systemize.

13. Battery safety switch according to claim 12, wherein the battery monitoring system monitors the voltage of the battery, the temperature of the battery and the current flowing into or out of the battery.

14. Battery safety switch according to claim 12, wherein the control unit determines the battery condition from the values measured by the battery monitoring system.

15. Battery safety switch according to claim 1, further comprising a monitoring device for monitoring the current flow out of the battery in the position Ignition OFF.

16. Battery safety switch according to claim 15, wherein the control unit averages the current values acquired by the monitoring device and on exceeding a specified limit also disconnects the loads connected in the position Ignition OFF from the battery.
